(19) United States
(12) Patent Application Publication
(10) Pub. No.: US 2016/0290308 A1
(43) Pub. Date: Oct. 6, 2016

(54) CATALYST LIGHT-OFF TIME REDUCTION AND MAINTENANCE

(71) Applicant: DENSO International America, Inc., Southfield, MI (US)

(72) Inventor: Edward Szczepanski, Grosse Pointe Woods, MI (US)

(21) Appl. No.: 14/672,761

(22) Filed: Mar. 30, 2015

(51) Int. Cl. F02P 5/15; F01N 3/20; F01N 11/00

(52) U.S. Cl. CPC F02P 5/1502; F01N 11/002; F01N 3/20

(57) ABSTRACT

A fast light-off time enhancement device and method may be used for an exhaust catalyst or particulate filter. The light-off time enhancement device may include a fuel injector, a carbon nano-tube injector, and a light source when active may generate heat. Heat generated thereby provides improving light-off time of the catalyst. Additionally, the same system may be used to generate heat to regenerate a particulate filter. An associated control system may be utilized to monitor vehicle parameters and determine the appropriate use of the light-off enhancement device.

### FIELD

This present disclosure relates to the field of automotive exhaust catalysts and particulate filters, more specifically this disclosure relates to a utilizing a ignition of fuels by light source to reduce light-off time and maintain catalyzation and filterization.

### BACKGROUND

This section provides background information related to the present disclosure which is not necessarily prior art.

In typical gasoline engine, the majority of the emissions that come out of the engine may be converted to clean output (H₂O and CO₂) by the catalyst in the catalytic converter. However, to maintain proper operation, the catalyst must be heated to a temperature equal to or above a light-off temperature and maintain that temperature. A typical light-off temperature threshold is approximately equal to 400° C., with the standard maintenance temperature ranging from 400° C. to 600° C. It is known in the art that a majority of the exhaust gas emissions that are captured exiting the exhaust gas treatment system during an emissions test occur during the first 60 seconds of engine operation while the catalyst temperature is below the light-off temperature, and cannot effectively convert the engine out emissions to H₂O and CO₂.

Conventional vehicle powertrains typically will execute a light-off strategy immediately upon starting the engine when the drivetrain is in park or neutral and hope to finish before the driver shifts into a drive gear and presses the accelerator pedal to drive away. Generally this strategy has the engine operate at a higher RPM to produce enough heat to decrease the catalyst light-off time. However, some hybrid powertrain combinations can achieve the maximum acceleration that the driver requests with the electric motors with no assistance needed from the conventional gas motor. Therefore, not allowing any hot exhaust gas to flow through the catalyst thus allowing the catalyst to cool below an effective temperature. Additionally, hybrid vehicles typically employ smaller engines, which produce less heat and are usually not allowed to idle, also engine warm-up time may be longer compared to conventional vehicles. A supplemental heating system or a light-off time enhancement device may be used to accelerate engine warm-up thus contributing to improved efficiency and emissions. It is also known that exhaust particulate filters use a similar light-off strategy to regenerate, essentially burn off the particulates captured in the filter.

### SUMMARY

This section provides a general summary of the disclosure, and is not a comprehensive disclosure of its full scope or all of its features.

An engine exhaust system that may comprise an engine and a housing that may be connected to the engine through an exhaust pipe. The housing may include at least one catalyst. Disposed upstream of the catalyst may be a light-off enhancement device. The light-off enhancement device may further comprise a fuel injector, a carbon nano-tube injector and a light source.

A vehicle exhaust system that may comprise a catalytic converter. Upstream of the catalytic converter may be a light-off enhancement device. A control module may be configured to receive temperature data that may represent temperature of the catalyst of the catalytic converter. The control module may also activate the light-off enhancement device if the temperature of the catalyst is below an effective temperature. The control module may activate the light-off enhancement device by communicating with and activate a fuel injector, a carbon nano-tube injector and a light source.

A catalyst light-off management method that may have the steps of monitoring the operation of an engine. If it is determined the engine is running then monitoring a catalyst temperature of a catalytic converter. Comparing the catalyst temperature to a preset light-off temperature. If it is determined that the catalyst temperature is below the preset light-off temperature, the control will power a light-off enhancement device to heat the catalytic converter. If the catalyst temperature is greater than or equal to the preset light-off temperature, the light-off enhancement device is disabled. Powering the light-off enhancement device may be activating a fuel injector to inject fuel upstream of the catalyst, initiating a carbon nano-tube injector to inject carbon nano-tubes upstream of the catalyst and powering a light source.

Another embodiment may be an exhaust system with a catalytic converter. A muffler disposed downstream of the catalytic converter.

The catalytic converter may contain a catalyst disposed inside. Upstream of the catalyst may be a combination injector that injects a mix of fuel and carbon nano-tubes. A light source may be disposed upstream of the catalyst.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

The drawings described herein are for illustrative purposes only of selected embodiments and not all possible implementations, and are not intended to limit the scope of the present disclosure.

FIG. 1 is a schematic representation of a vehicle having a exhaust system;

FIG. 2 is a representation of an exhaust system;

FIG. 3 is block diagram of a control strategy;

FIG. 4 is a representation of an additional embodiment of an exhaust system;

FIG. 5 is block diagram of another control strategy; and

FIG. 6 is a representation of an additional embodiment of an exhaust system.

Corresponding reference numerals indicate corresponding parts throughout the several views of the drawings.

### DETAILED DESCRIPTION

Example embodiments will now be described more fully with reference to the accompanying drawings. The following description is merely exemplary in nature and is not intended to limit the present disclosure, application, or uses. It should be understood that throughout the drawings, corresponding reference numerals indicate like or corresponding parts and features.

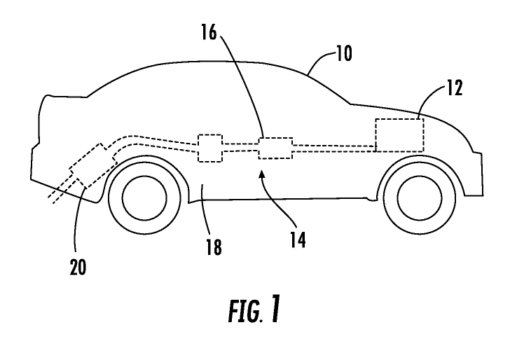

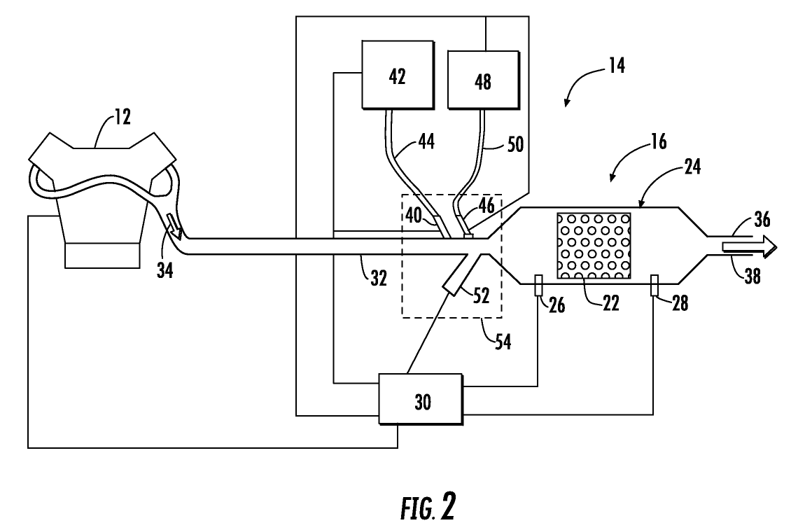

FIG. 1 depicts a vehicle 10 with an internal combustion engine 12, whether the sole source or joint source of vehicle power, produces exhaust gas which is expelled through exhaust system 14. The exhaust system 14 may contain a catalytic converter 16, a particulate filter 18, and a muffler 20. FIG. 2 depicts an exploded block view of the exhaust system 14. The exhaust system 14 includes a catalytic converter 16 which may include a catalyst 22, also may be known in the art as a reforming catalyst, an exhaust treatment catalyst by way of non-limiting example. The catalyst 22 is disposed within the housing 24. The catalyst 22 may comprise any catalyst material suitable for treatment of vehicle exhaust, including, but not limited to, for example, rhodium, platinum, their alloys, and combinations thereof. It is also known in the art that the catalytic converter 16 may contain multiple catalysts 22 within the housing 24 that may be in series to increase the effectiveness of reforming the exhaust. The exhaust system 14 may also include an upstream temperature sensor 26 that may be coupled to the housing 24 upstream of the catalyst 22. A downstream temperature sensor 28 may be coupled to the housing 24 downstream of the catalyst 22. The upstream temperature sensor 26 and downstream temperature sensor 28 may communicate with a control module 30; the engine may also communicate with the control module 30. The upstream temperature sensor 26 and downstream temperature sensor 28 may also be embedded into the catalyst 22 by way of non-limiting example. The catalytic converter 16 may be connected to engine 12 by an exhaust pipe 32. Untreated exhaust 34 leaves the engine 12 and flows through exhaust pipe 32 to the catalytic converter 16 to be treated. The treated exhaust gas 36 leaves the catalytic converter 16 into the tail pipe 38 to muffler 20.

The current embodiment may also contain a fuel injector 40 that may inject fuel upstream of the catalyst 22 in the exhaust system 14. The fuel injector 40 receives fuel from fuel storage 42 through conduit 44. The fuel storage 42 may be an independent reservoir or part of the vehicle main fuel supply tank for the engine 12 to reduce complexity of parts. The fuel that may be injected into the flow of exhaust gas from the engine 12 may include but not limited to gasoline, diesel fuel, or any combustible fuel that may be available. The fuel injector 40 and fuel storage 42 communicate with a control module 30. The exhaust system 14 may also include a carbon nano-tube (CNT) injector 46 that may inject CNT's upstream of catalyst 22. The CNT injector 46 may receive CNT's from CNT storage 48 through conduit 50. The CNT injector 46 and CNT storage 48 communicate with a control module 30. The exhaust system 14 may also include a light source 52 upstream of catalyst 22. The light source 52 may communicate with control module 30 and may be downstream of fuel injector 40 and CNT injector 46. This may allow fuel and CNT's to properly mix before light source 52 activates to ignite the mix. The fuel injector 40, CNT injector 46, and light source 52 may be collectively referred to as supplemental heating system or a light-off time enhancement device indicated by dotted box 54.

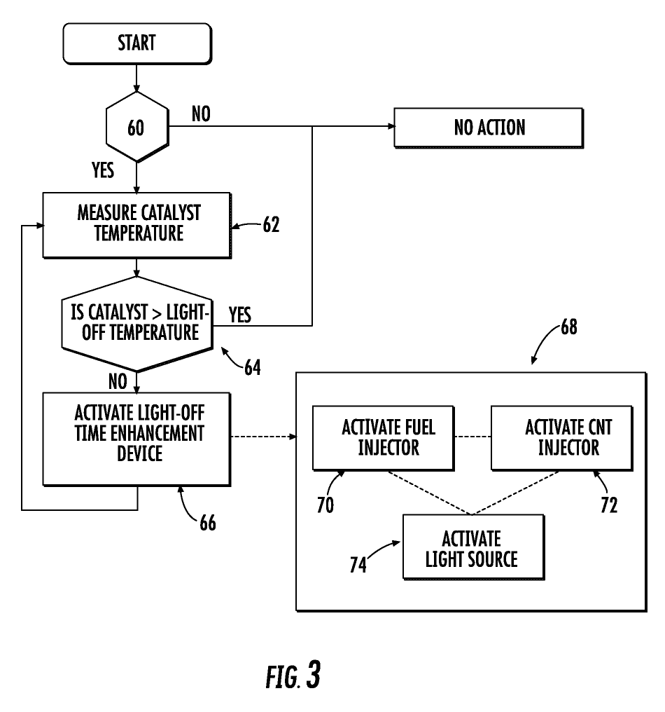

The general operation of the exhaust system 14 and light-off time enhancement device 54 will be described using structure in FIG. 2 and flow chart represented by FIG. 3. The control module 30 may be programed to conduct the logic into whether the light-off time enhancement device 54 needs to be active or not, it is understood in the art that this control module 30 can be any suitable module or computer to receive and send information within the vehicle 10. In decision block 60 control module 30 determines whether the engine 12 is running therefore may be generating untreated exhaust 34. If the engine 12 is not running than the logic stops. If the engine 12 is running the control module communicates with temperature sensors 26 and 28 to determine the temperature of the catalyst 22, represented by block 62. Block 64 represents the control module 30 determining if the catalyst 22 is above the preset light off temperature. If yes then no action, if no then the light-off time enhancement device 54 may be activated, represented by block 66. Activating the light-off enhancement device, represented by block 68, may comprise injecting fuel from fuel injector 40, represented by block 70 and injecting CNT's from CNT injector 46, represented by block 72. The control module 30 may active a light source 52, block 74, to ignite the CNT's which ignites the fuel injected by injector 40. The heat created by the ignition may heat up the catalyst 22. The control module 30 will continue to monitor the temperature of the catalyst 22, block 62, once the light-off temperature is reached, the light-off time enhancement device 54 may be inactive. This strategy can be utilized upon cold start of a vehicle 10, or in the case of a hybrid vehicle to maintain catalyst 22 light-off temp in series of engine 12 stops and starts.

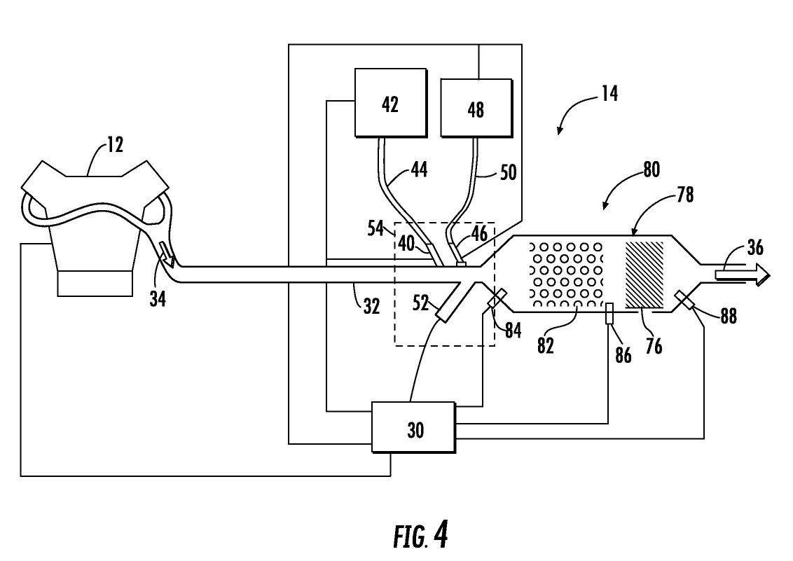

An additional embodiment is represented by FIG. 4. In this embodiment the general exhaust layout is similar to FIG. 2 however a particulate filter 76 may be included in the housing 78 of the catalytic converter with particulate filter assembly 80. A catalyst 82 may also be in the same housing 78. An upstream temperature sensor 84 is coupled to the housing 78 upstream of the catalyst 82; a middle temperature sensor 86 may be coupled to the housing 78 upstream of the particulate filter 76 but downstream of the catalyst 82. A downstream temperature sensor 88 may be coupled to the housing 78, wherein all temperature sensors may communicate with control module 30. Temperature sensors 84, 86, 88 may be embedded into the catalyst and/or the filter by way of non-limiting example. In this embodiment the light-off time enhancement device 54 may be used to generate a great amount of heat to regenerate or burn off any trapped particles in the particulate filter 76. It can be understood in the art the that particulate filter 76 and catalyst 82 may be in separate housings and may require two light-off enhancement devices 54. The catalyst 82 and particulate filter 76 are shown together as a non-limiting example.

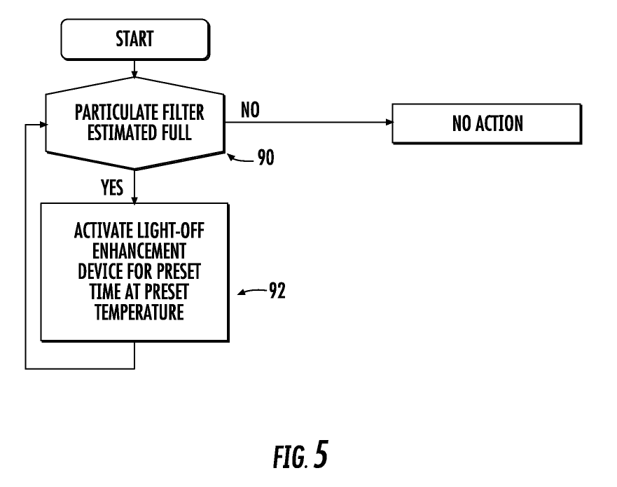

FIG. 5 represents the flow chart of control for regenerating the particulate filter 76. The control module 30 selectively enables particulate filter regeneration, which is initiated when the control module 30 estimates the particulate filter 76 is full of particulates; this is represented by block 90. The control module 30 may continuously estimate the amount of emitted particulates since the last regeneration based on engine operating parameters. If the particulate filter 76 is determined not to be full then no action is taken. It is known in the art that regeneration is preferably initiated during conditions where exhaust temperatures exceed the required light-off threshold without special actions. For example, particulate filter 76 regeneration may be initiated during traveling at highway speeds. However, regeneration can be initiated at less than optimum conditions if required. The duration of particulate filter 76 regeneration varies based on the amount of estimated particulates within the particulate filter 76. If the control module 30 determines the particulate filter is full it may initiate the light-off enhancement device 54 for a preset time at a preset temperature, represented by box 92. The control module 30 will monitor the temperatures in the catalyst particulate filter assembly 80 using temperature sensors 84, 86, and 88. The light-off enhancement device 54 operation is consistent with what was previously described. Once the preset time at the preset temperature is met the operation may stop and the estimating process of step 90 starts over again.

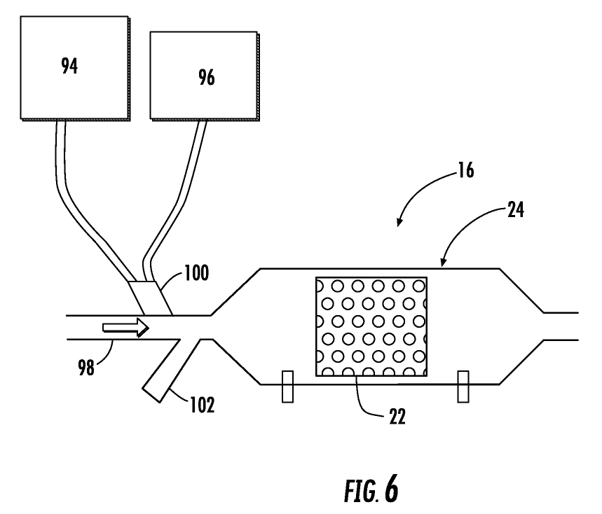

FIG. 6 represents an additional embodiment where the fuel from fuel supply storage 94 and CNT's from CNT storage 96 are delivered into the exhaust stream 98 through a combination injector 100. A light source 102 may remain separate and downstream from the combination injector 100. This configuration may allow for a thorough mix of fuel and CNT's, when the light source 102 is activated. A complete burn of fuel may be obtained for increased heat for catalyst 22 and efficiency as to not waste any fuel that is being injected. The control would operate in the same manner previously described and may be controlled by control module 30. It can also be appreciated for this embodiment and the all previous embodiments that the location of the light-off enhancement device 54, or combination injector 100 and light source 102 may be coupled to the exhaust pipe 32 leading to the catalytic converter 16 or the actual catalytic converter housing 24.

A unique property of CNT's is their ability to heat up and burn upon exposure to light. The present embodiments utilize this property as an ignition method that is simplistic in nature and versatile. The light source 52, 102 may be a flash device similar to those used with ordinary camera equipment or a flashlight by way of non-limiting example. Light sources 52, 102 could also be, without limitation, a light-emitting diode, laser diode, a laser, an arc lamp, LED, fiber optic or other light emitting device. By utilizing basic light sources this may reduce cost and complexity to implement an conventional igniting device in the exhaust system 14. By utilizing CNT's mixed with fuel a more efficient ignition may be obtained as to not waste any of the fuel being supplied. Further details about CNT's and light source ignition can be found in U.S. Pat. Nos. 7,517,215 and 7,217,404 which are both incorporated herein by reference. Additionally information about igniting nanoparticles by using optical ignition can be found in US Application 2012/1511931 which is incorporated herein by reference. Additionally the creation of CNT's in US Application 2007/0025905 which is incorporated herein by reference.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A engine exhaust system comprising:
a engine;
a housing, the housing fluidly connected to the engine through an exhaust pipe;
at least one catalyst disposed in the housing;
a light-off enhancement device disposed upstream of the catalyst; wherein the light-off enhancement device further comprises a fuel injector, a carbon nano-tube injector and a light source.

2. A engine exhaust system according to claim 1, further comprising
a control module
a first temperature sensor disposed between the light-off enhancement device and catalyst; and
a second temperature sensor disposed downstream of the catalyst, wherein the control module communicates with the first and second temperature sensor.

3. A engine exhaust system according to claim 2, wherein the control module communicates with the engine, the fuel injector, the nano-tube injector and the light source.

4. A engine exhaust system according to claim 3, wherein,
the control module is configured to determine if the engine is running, receive temperature data from the first and second temperature sensors, and activate the fuel injector, the nano-tube injector and the light source if the temperature of the first and second temperature sensors is below an effective temperature.

5. A engine exhaust system according to claim 4, wherein,
the control module is configured to determine if the engine is running, receive temperature data from the first and second temperature sensors, and deactivate the fuel injector, the nano-tube injector and the light source if the temperature of the first and second temperature sensors is at or below an effective temperature.

6. A engine exhaust system according to claim 1, further comprising
a first temperature sensor disposed between the light-off enhancement device and catalyst; and
a second temperature sensor disposed downstream of the catalyst,
a particulate filter downstream of the second temperature sensor;
a third temperature sensor disposed downstream of the particulate filter; and
a control module; wherein the control module communicates with the first, second, and third temperature sensors, the engine, the fuel injector, the nano-tube injector and the light source.

7. A engine exhaust system according to claim 6, wherein
the particulate filter is disposed in the housing and the third temperature sensor is coupled to the housing.

8. A engine exhaust system according to claim 1, further comprising
a fuel supply; wherein the fuel supply is fluidly coupled to the engine and the fuel injector.

9. A vehicle exhaust system comprising:
a catalytic converter;
a light-off enhancement device upstream of the catalytic converter; and
a control module configured to receive temperature data representing temperature of a catalyst disposed within the catalytic converter, activate the light-off enhancement device if the temperature of the catalyst is below an effective temperature; wherein the light-off enhancement device further comprises a fuel injector, a carbon nano-tube injector and a light source.

10. A vehicle exhaust system according to claim 9, further comprising
a first temperature sensor; and
a second temperature sensor; wherein the first temperature sensor disposed between the light-off enhancement device and the catalyst; and
a second temperature sensor disposed downstream of the catalyst.

11. A vehicle exhaust system according to claim 10, wherein the control module is in communication with the first temperature sensor and the second temperature sensor.

12. A vehicle exhaust system according to claim 10, further comprises
a particulate filter disposed within the catalytic converter downstream the second temperature sensor; and
a third temperature sensor downstream the particulate filter in communication with the control module.

13. A vehicle exhaust system according to claim 10, further comprising
a particulate filter disposed downstream of the second temperature sensor; and
a third temperature sensor downstream the particulate filter in communication with the control module.

14. A catalyst light-off management method, comprising the steps of:
monitoring the operation of an engine; if the engine is running;
monitoring a catalyst temperature of a catalytic converter;
comparing the catalyst temperature to a light-off temperature; if the catalyst temperature is below the light-off temperature, powering a light-off enhancement device to heat the catalytic converter; if the catalyst temperature is greater than or equal to the light-off temperature, disabling the light-off enhancement device; wherein
powering the light-off enhancement device further comprises initiating a fuel injector to inject fuel upstream of the catalyst, initiating a carbon nano-tube injector to inject carbon nano-tubes upstream of the catalyst and powering a light source.

15. A catalyst light-off management method according to claim 14, further comprising monitoring operation parameters of the engine; and
determining the level of particulate in a particulate filter based the operation parameters, if determined that the particulate filter is full, powering the light-off enhancement device for a preset period of time.

16. A exhaust system comprising:
a catalytic converter;
a muffler disposed downstream of the catalytic converter;
at least one catalyst disposed in the catalytic converter;
a combination injector that injects a mix of carbon nano-tubes and fuel upstream of the catalyst; and
a light source disposed upstream of the catalyst.

17. A exhaust system according to claim 16 wherein the light source is disposed between the single injector and the catalyst.

18. A exhaust system according to claim 16 further comprising a particulate filter disposed between the catalyst and the muffler.
